(19) United States
(12) Patent Application Publication
(10) Pub. No.: US 2013/0159094 A1
(43) Pub. Date: Jun. 20, 2013

(54) REAL TIME AD TARGETING

(71) Applicants: Steven Andrew McClelland, San Francisco, CA (US); Sarah Jean Sosiak, San Francisco, CA (US); Fernando Padilla, San Francisco, CA (US)

(72) Inventors: Steven Andrew McClelland, San Francisco, CA (US); Sarah Jean Sosiak, San Francisco, CA (US); Fernando Padilla, San Francisco, CA (US)

(73) Assignee: YAHOO! INC., Sunnyvale, CA (US)

(21) Appl. No.: 13/326,033

(22) Filed: Dec. 14, 2011

(51) Int. Cl. G06Q 30/02

(52) U.S. Cl. 705/14.49; 705/14.71

(57) ABSTRACT

In one embodiment, an event that has recently occurred is identified. The event is categorized into a category of events from a plurality of categories. A set of one or more advertisements associated with the category of events is ascertained. At least one advertisement is selected from the set of one or more advertisements associated with the category of events. The at least one advertisement is then provided to a user.

### BACKGROUND OF THE INVENTION

The disclosed embodiments relate generally to methods and apparatus for advertising to users based, at least in part, upon the occurrence or detection of events.

Advertisers typically pay online publishers to place their ads on a web page. In a popular pricing model, an advertiser is charged based upon the number of impressions that are delivered. Other pricing models may also be used. For example, in the pay-per-click mode, each advertiser is typically charged only when her ad receives a click.

Advertisers generally request that a minimum number of impressions (i.e., views) be guaranteed. In addition, advertisers may also specify additional conditions that are to be satisfied by the online publisher of the ads. For example, the advertisers may specify a desired target profile of users who are to receive a particular advertisement. As another example, advertisers may also specify a particular position in which an advertisement is to be placed on a web page. A publisher will therefore typically attempt to maximize their profits (e.g., by achieving high click-through-rates), while satisfying the requirements of the advertisers. Unfortunately, selecting advertisements to be provided to users while satisfying the requirements of advertisers is a complex process.

### SUMMARY OF THE INVENTION

The disclosed embodiments enable ad targeting to be performed based, at least in part, upon the occurrence or detection of an event. More particularly, an event that falls within a particular category may trigger the delivery of advertisement(s) corresponding to that category.

In one embodiment, a plurality of bids may be obtained for a category of events, where each of the plurality of bids pertains to one of a plurality of advertisements. A set of one or more of the plurality of advertisements may be selected based, at least in part, upon the plurality of bids. The set of one or more of the plurality of advertisements may be associated with the category of events.

In another embodiment, an event that has recently occurred may be identified. The event may be categorized into a category of events from a plurality of categories. A set of one or more advertisements associated with the category of events may be ascertained. At least one advertisement may be selected from the set of one or more advertisements associated with the category of events. The at least one advertisement may then be provided to a user.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIG. 2 is a process flow diagram illustrating an example method of serving advertisements in accordance with various embodiments.

FIG. 3 is a process flow diagram illustrating an example method of processing bids in association with advertisements in accordance with various embodiments.

FIG. 4 is a simplified diagram of an example network environment in which various embodiments may be implemented.

FIG. 5 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

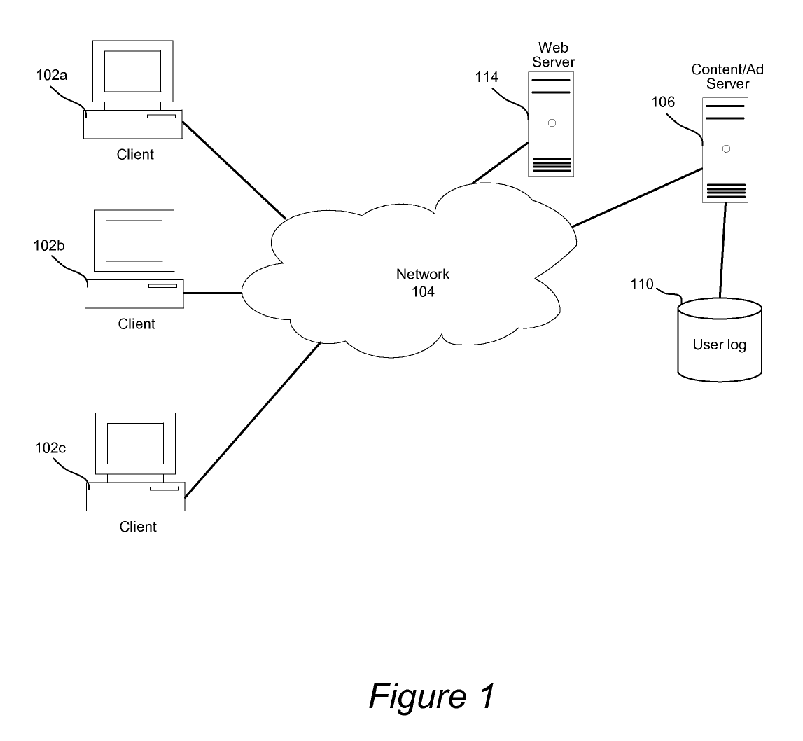

FIG. 1 illustrates an example network segment in which various embodiments of the invention may be implemented. As shown, a plurality of clients 102a, 102b, 102c may each receive an impression (i.e., view) of one or more advertisements upon accessing a web page via a web server 114, as will be described in further detail below. Alternatively, an advertisement may be transmitted to the clients 102a, 102b, 102c by the ad server(s) 106 via another mechanism such as electronic mail, text message, or digital television. Advertisements may be transmitted via an ad server 106, which may be coupled to the web server 114, as shown. However, it is important to note that the disclosed embodiments may be implemented via any number of servers.

The clients 102a, 102b, 102c may be coupled to the web server 114 via a network 104. The network 104 may take any suitable form, such as a wide area network or Internet and/or one or more local area networks (LAN's). The network 104 may include any suitable number and type of devices, e.g., routers and switches, for forwarding data and/or search or web object requests from each client to the search or web application and search or web results back to the requesting clients.

The web server 114 may provide services associated with a social network. Example social networks include, but are not limited to, Yahoo, Facebook, Twitter, and Linked In. The services provided by the social network may include matchmaking services, social or business networking services, messaging services, and/or the ability to share content such as photos or videos.

The ad server 106 (or servers) of the online publisher may have access to one or more user logs 110 (e.g., user databases) into which user information is retained. This user information or a portion thereof may be referred to as a user profile. More particularly, the user profile may include public information that is available in a public profile and/or private information. The user logs 110 may be retained in one or more memories that are coupled to the ad server 106.

The user information retained in the user logs 110 may include personal information such as demographic information (e.g., age and/or gender) and/or geographic information (e.g., residence address, work address, and/or zip code). In addition, each time a user performs online activities such as clicking on an advertisement or purchasing goods or services, information regarding such activity or activities may be retained as user data in the user logs 110. For instance, the user data that is retained in the user logs 110 may indicate the identity of web sites visited, identity of ads that have been selected (e.g., clicked on) and/or a timestamp. Moreover, where the online publisher supports a search engine (e.g., via the ad server 106 or a separate search server), information associated with a search query, such as search term(s) of the search query, information indicating characteristics of search results that have been selected (e.g., clicked on) by the user, and/or associated timestamp may also be retained in the user logs 110. A user may be identified in the user logs 110 by a user ID (e.g., user account ID), information in a user cookie, etc.

Embodiments disclosed herein for selecting an advertisement to deliver to a user may be implemented via the ad server 106. Furthermore, embodiments for charging advertisers for the delivery of advertisements may also be implemented via the ad server 106. The disclosed embodiments may be implemented via software and/or hardware.

An online publisher (i.e., web publisher) will generally be responsible for delivering multiple advertisements via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

An advertisement may include content pertaining to a product or service, which may be delivered via the Internet, email, text message, or digital television. The content typically includes text. However, it is important to note that an advertisement may include text, one or more images, video, and/or audio. An advertisement may also include one or more hypertext links, enabling a user to proceed with the purchase of a particular product or service.

The disclosed embodiments support the dynamic selection and transmission of advertisements to users. Advertisements may be provided to users via a variety of communication media including, but not limited to, a web site (e.g., via display on a web page of the web site), electronic mail, Short Message Service (SMS), a mobile device (e.g., text message), or another medium such as digital television, which may be connected to the Internet. For instance, selected advertisement(s) may be provided to a user via the Internet. Specifically, when a user visits a web page via the Internet, the system (e.g., ad server 106) may automatically select an advertisement to be served to the user (e.g., by placing the advertisement in the web page). The publisher may then automatically provide the selected advertisement(s) to the user.

When an advertisement is provided to a particular user, information pertaining to the advertisement (e.g., identifying a product or service advertised in the advertisement) may be stored in association with the user's account data. In addition, the server(s) 106 may automatically collect online (and/or real world) behavioral data for any of users 102a, 102b, 102c to determine whether the advertisement was successful. In other words, the server(s) 106 may determine whether the user purchased the product or service advertised in the advertisement. Data indicating whether the advertisement was successful may also be stored in association with the user's account data and/or the advertisement.

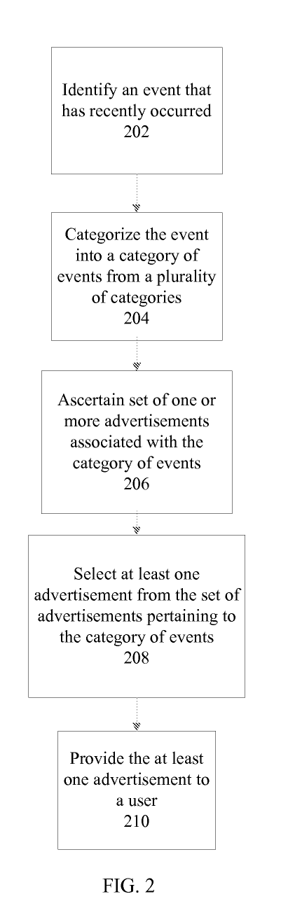

FIG. 2 is a process flow diagram illustrating an example method of serving advertisements in accordance with various embodiments. The system may identify an event that has recently occurred at 202. More particularly, the system may identify the event based, at least in part, upon a set of one or more news stories. For example, the system may continuously monitor one or more web sites (e.g., news web sites) to quickly identify event(s) that fall within one or more of a plurality of categories.

The system may then categorize the event into a category of events from the plurality of categories at 204. Each of the categories may identify a different category of events. More particularly, the categories may be distinguished by topic, theme (e.g., Halloween, children), type of event and/or urgency of the category of events. An example set of categories of events may include local emergencies such as earthquakes, fires, or floods, or worldwide emergencies such as stock market crashes or recessions. As another example, categories of events may pertain to peaking events that indicate optimal timing for advertising particular categories of services or products. For example, a first category of events may pertain to solar energy, while a second category of events may pertain to electric cars. Peaking events may include events such a drop in prices or sale for a particular type of product (e.g., cars), a recent rise in prices for a particular type of product, a general reduction in inventory of a particular type of product, etc.

The system may ascertain a set of one or more advertisements associated with (e.g., pertaining to) the category of events at 206, and select at least one advertisement from the set of advertisements associated with the category of events at 208. More particularly, the system may select an advertisement that is most relevant to the user based, at least in part, upon the user profile.

The system may then provide the selected advertisement(s) to a user at 210. More particularly, the system may ascertain a set of one or more users to which the category of events is pertinent (e.g., based upon user profile(s)), and select a user from the set of one or more users. Alternatively, the system may simply provide the selected advertisement(s) to a user accessing a web site. Moreover, the system may provide the selected advertisement(s) to the user after determining that the category of events is pertinent to that user (e.g., based upon the user's profile).

In accordance with various embodiments, the system may provide the selected advertisement(s) to the user within (or after) a pre-determined period of time from when the event occurred or from when the event was detected. For example, the system may provide the selected advertisement(s) to the user within 5 minutes from when the event occurred or from when the event was detected in order to maximize the benefit of the occurrence of the event. In this manner, the system may provide real-time ad targeting that is appropriate for the event that occurred. Alternatively, the system may provide the selected advertisement(s) to the user in response to input from the user.

The price that an advertiser is charged for providing an advertisement may be based upon one or more factors. More particularly, the price maybe based, at least in part, upon the category events. For example, each of a plurality of category of events may have a corresponding price. Moreover, the price may be based, at least in part, upon a period of time that has passed since the event occurred or since the event was detected. Therefore, pricing may be determined dynamically based upon the urgency of the event or time period during which advertisements are likely to be of interest to users receiving the advertisements.

In accordance with various embodiments, a user may opt-in to the system for providing real-time ad targeting based upon the occurrence of various events. During the process of opting-in to the system, the user may indicate their preferences by declaring an interest in one or more categories of events, or simply opt-in to receive advertisements pertaining to any of a plurality of categories of events. The user may receive various benefits as a result of opting in. For example, the user may receive monetary payment, discounts, or other services in return for the user opting in to the system.

Bidding Platform

In accordance with various embodiments, a Bidding Platform may enable bids to be placed on any of a plurality of categories of events. A bid may therefore be placed on a category by selecting the corresponding category. Alternatively, categories may be defined as a result of the bidding process (e.g., by providing one or more keywords). In this manner, an advertiser or application developer/owner may place a bid on a particular category of events.

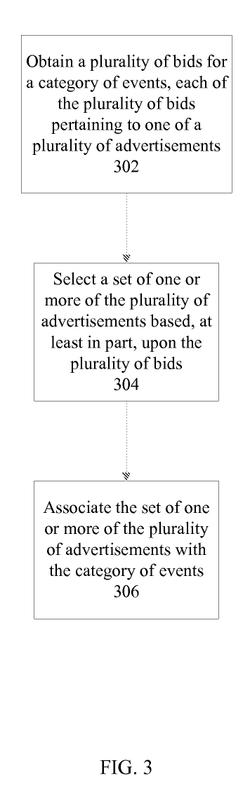

In accordance with various embodiments, each category of events may be auctioned such that a set of advertisements is associated with the category of events. In this manner, advertisers may preauthorize advertisements to be delivered in accordance with the occurrence of various categories of events (e.g., peaking events). FIG. 3 is a process flow diagram illustrating an example method of processing bids in association with advertisements in accordance with various embodiments. The system may obtain a plurality of bids for a category of events (e.g., from a plurality of advertisers) at 302, where each of the plurality of bids pertains to one of a plurality of advertisements. For example, the system may present a plurality of categories via a graphical user interface, enabling an advertiser to select one or more categories in association with a particular advertisement for which one or more bids are being submitted. Each of the bids may further specify a number of impressions and a target population to which the number of impressions of the advertisement are to be delivered. In this manner, advertisers may place a “standing limit order” on a particular category (e.g., one or more keywords defining the category).

The system may select a set of one or more of the plurality of advertisements at 304 based, at least in part, upon the plurality of bids. For example, the system may select a pre-defined number of the plurality of advertisements according to a bid amount of each of the plurality of bids. The system may then associate the set of one or more of the plurality of advertisements with the category of events at 306.

The process described above with reference to FIG. 3 may be performed for each of a plurality of categories of events such that each of the plurality of categories of events is associated with a different corresponding set of one or more advertisements. It is important to note that an advertiser may submit more than one bid in association with a single advertisement. As a result, an advertisement may be associated with more than one category of events.

Each category of events may be defined by one or more keywords. An event may be determined to fall within a particular category if the keywords defining the category are found within one or more news stories pertaining to the event. Similarly, a category may be determined to be pertinent to a particular individual if the keywords defining the category are identified in the user's profile. For example, the system may consider the user's prior purchases, declared interests, implied interests (e.g., based upon prior search queries), etc.

In accordance with various embodiments, a category of events may be defined by one or more rules using terms such as “OR,” “AND,” and “NOT.” For example, a category pertaining to natural disasters may be defined by a rule such as “Flood OR fire OR earthquake.” An event may be determined to fall within a category of events if the particular rule is satisfied by one or more news stores pertaining to the event. Similarly, a category may be determined to be pertinent to a particular individual if the rule is satisfied by the user's profile. For example, the system may consider the user's prior purchases, declared or implied interests, etc.

Each category of events may have associated therewith a time period during which advertisements in the set of advertisements are to be provided to users. For example, an advertisement associated with a category of events pertaining to local emergencies may be provided immediately to users. As another example, an advertisement associated with a category of events pertaining to electric cars may be provided within a day of the occurrence or detection of an event within that category of events.

A bidder may specify an advertisement in association with one or more bids through various mechanisms. For example, the bidder may identify a name of the advertisement or a location at which the advertisement can be obtained. As another example, the bidder may upload the advertisement in association with the bid. In addition, the bidder may specify or bid on a time period during (or after) which the advertisement is to be provided, where the time period is measured from the occurrence or detection of the event. For example, one bidder may indicate that a particular advertisement is to be provided within 5 minutes from the occurrence or detection of an event within the category of events, while another bidder may indicate that another advertisement is to be provided within a day from the occurrence or detection of an event within the category of events. As another example, an advertiser may wish to advertise financial services 1 day after the Dow drops 500 points. The price for such advertising may vary according to the time period indicated by the bidder. However, it is important to note that the highest price may not correspond to the minimum time period. Rather, the highest price may correspond to the optimal time period. For example, it may be optimal to advertise 1 week after a stock market crash versus 1 day after a stock market crash.

In addition, the system may provide information pertaining to each of the plurality of categories to potential advertisers via the Bidding Platform. More particularly, the system may indicate the number of users to which a particular category is pertinent. The system may also indicate the number of users that have opted-in to the system and/or the number of users that have declared an interest in a particular category.

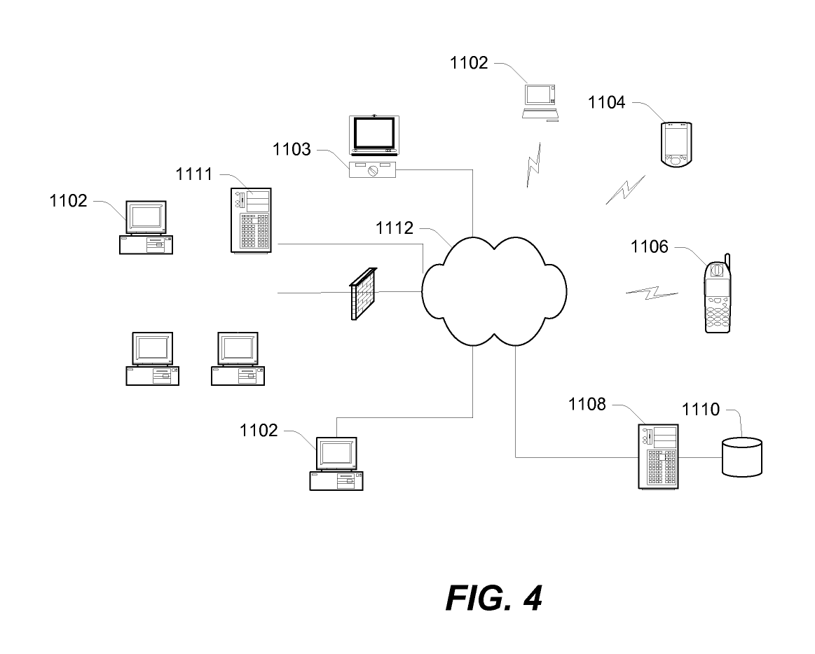

The disclosed embodiments may be implemented in any of a wide variety of computing contexts. For example, as illustrated in FIG. 4, implementations are contemplated in which users interact with a diverse network environment via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, input that is processed in accordance with the invention may be obtained using a wide variety of techniques. For example, input received via the Bidding Platform or from a user opting-in to the system may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Real time ad targeting may be implemented according to the disclosed embodiments in some centralized manner. This is represented in FIG. 4 by server 1108 and data store 1110 which, as will be understood, may correspond to multiple distributed devices and data stores. The data store 1110 may store user account data, profiles, and/or preferences, advertisements and/or advertisement information (e.g., advertisement identifiers), mappings between advertisements and categories, category definitions (e.g., keywords or rules), advertising bids, and/or total charges accrued in association with various advertisements or advertisers. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

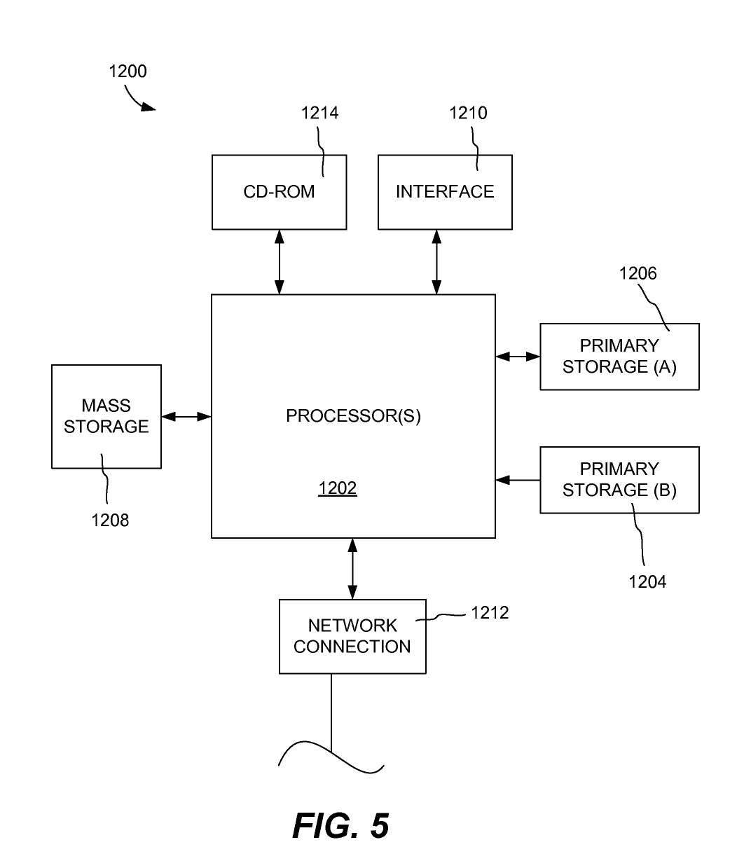

FIG. 5 illustrates a typical computer system that, when appropriately configured or designed, can serve as a system of this invention. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
identifying by a network device an event that has recently occurred;
categorizing by the network device the event into a category of events from a plurality of categories;
ascertaining by the network device a set of one or more advertisements associated with the category of events;
selecting by the network device at least one advertisement from the set of one or more advertisements associated with the category of events; and
providing by the network device the at least one advertisement to a user.

2. The method as recited in claim 1, further comprising:
ascertaining by the network device a set of one or more users to which the category of events is pertinent; and
selecting the user from the set of one or more users

3. The method as recited in claim 1, wherein identifying by the network device a an event that has recently occurred comprises:
identifying the event that has recently occurred based, at least in part, upon a set of one or more news stories.

4. The method as recited in claim 1, further comprising:
auctioning the category of events such that the set of one or more advertisements are associated with the category of events prior to performing the identifying, categorizing, ascertaining, selecting, and providing steps.

5. The method as recited in claim 1, further comprising:
obtaining a plurality of bids for the category of events, each of the plurality of bids pertaining to one of a plurality of advertisements; and
selecting the set of one or more advertisements from the plurality of advertisements based, at least in part, upon the plurality of bids.

6. The method as recited in claim 1, wherein providing by the network device the at least one advertisement to the user comprises:
providing the at least one advertisement to the user within a pre-determined period of time from when the event occurred or from when the event was detected.

7. The method as recited in claim 1, wherein providing by the network device the at least one advertisement to the user comprises:
providing the at least one advertisement to the user in response to input from the user.

8. The method as recited in claim 1, wherein the category of events is defined by a set of one or more keywords or one or more rules.

9. The method as recited in claim 1, further comprising:
charging an amount for the providing, wherein the amount is based, at least in part, upon the category of events.

10. The method as recited in claim 1, further comprising:
charging an amount for the providing, wherein the amount is based, at least in part, upon a period of time that has passed since the event occurred or since the event was detected.

11. A method, comprising:
obtaining a plurality of bids for a category of events, each of the plurality of bids pertaining to one of a plurality of advertisements;
selecting a set of one or more of the plurality of advertisements based, at least in part, upon the plurality of bids; and
associating the set of one or more of the plurality of advertisements with the category of events.

12. The method as recited in claim 11, wherein the category of events is defined by one or more keywords or one or more rules.

13. The method as recited in claim 11, further comprising:
identifying an event that has recently occurred;
categorizing the event into a category of events from a plurality of categories;
ascertaining a set of one or more advertisements associated with the category of events;
selecting at least one advertisement from the set of one or more advertisements associated with the category of events; and
providing the at least one advertisement to a user.

14. The method as recited in claim 13, further comprising:
determining that the category of events is relevant to the user.

15. The method as recited in claim 13, further comprising:
charging an amount for the providing, wherein the amount is based, at least in part, upon the category of events.

16. The method as recited in claim 13, further comprising:
charging an amount for the providing, wherein the amount is based, at least in part, upon a period of time that has passed since the event occurred or since the event was detected.

17. A non-transitory computer-readable medium storing thereon computer-readable instructions, comprising:
instructions for identifying by a network device an event that has recently occurred;
instructions for categorizing the event into a category of events from a plurality of categories;
instructions for ascertaining a set of one or more advertisements pertaining to the category of events;
instructions for selecting by the network device at least one advertisement from the set of one or more advertisements pertaining to the category of events; and
instructions for providing by the network device the at least one advertisement to a user.

18. The non-transitory computer-readable medium as recited in claim 17, further comprising:
instructions for determining that the category of events is relevant to the user.

19. The non-transitory computer-readable medium as recited in claim 17, further comprising:
instructions for charging an amount for the providing, wherein the amount is based, at least in part, upon the category of events.

20. The non-transitory computer-readable medium as recited in claim 17, further comprising:
instructions for charging an amount for the providing, wherein the amount is based, at least in part, upon a period of time that has passed since the event occurred or since the event was detected.

21. The non-transitory computer-readable medium as recited in claim 17, further comprising:
instructions for obtaining an indication from a user indicating that the user is opting in to receive advertisements pertaining to the plurality of categories of events.

22. The non-transitory computer-readable medium as recited in claim 17, further comprising:
instructions for obtaining an indication from a user indicating that the user is opting in to receive advertisements pertaining to one or more of the plurality of categories of events.

23. An apparatus, comprising:
a processor; and
a memory, at least one of the processor or the memory being configured for:
obtaining a plurality of bids for a category of events, each of the plurality of bids pertaining to one of a plurality of advertisements;
selecting a set of one or more of the plurality of advertisements based, at least in part, upon the plurality of bids; and
associating the set of one or more of the plurality of advertisements with the category of events.

24. The apparatus as recited in claim 23, wherein each of the plurality of bids indicates a number of impressions and a target population, at least one of the processor or the memory being configured for performing steps, comprising:
providing at least one of the plurality of advertisements in response to detection of an event that is determined to be categorized in the category of events.

25. The apparatus as recited in claim 24, wherein the category of events has associated therewith a time period, wherein providing at least one of the plurality of advertisements is performed according to the time period.

26. The apparatus as recited in claim 23, wherein each of the plurality of bids further comprises an indication of a time period, wherein the corresponding one of the plurality of advertisements is to be provided according to the time period.

27. The apparatus as recited in claim 26, at least one of the processor or the memory being configured for performing steps, further comprising:
charging an amount for the providing, wherein the amount is based, at least in part, upon the time period.

28. The apparatus as recited in claim 23, at least one of the processor or the memory being configured for performing steps, further comprising:
providing an indication of a number of users having an interest in the category of events.
